(19) United States
(12) Patent Application Publication
(10) Pub. No.: US 2006/0169089 A1
(43) Pub. Date: Aug. 3, 2006

(54) Rake and telescope mechanism

(75) Inventor: Hitonobu Ohtsu, Tokyo (JP)

Correspondence Address: DELPHI TECHNOLOGIES, INC., M/C 480-410-202, PO BOX 5052, TROY, MI, 48007, US

(73) Assignee: Delphi Technologies, Inc.

(21) Appl. No.: 11/050,260

(22) Filed: Feb. 3, 2005

(51) Int. Cl. B62D 1/18

(52) U.S. Cl. 74/493

(57) ABSTRACT

The invention provides a steering column for a vehicle. The steering column includes a rake bracket having first and second side walls. The steering column also includes a first steering column member disposed between the first and second side walls for raking movement. The first steering column member includes a first aperture and a plurality of projections extending inwardly from the first aperture. The steering column also includes a second steering column member received in the first aperture for telescoping movement relative to the first steering column member. The steering column also includes a lock operable in a locked configuration to concurrently urge the first and second side walls of the rake bracket together to prevent the raking movement and urge the second steering column member and the plurality of projections together to prevent the telescoping movement.

### FIELD OF THE INVENTION

The invention relates to a steering column of a vehicle and more particularly to a steering column with a lock for selectively preventing telescoping and raking movement of the steering column.

### BACKGROUND OF THE INVENTION

Steering columns are disposed in vehicles to support the steering wheel for use by the driver. Steering columns can be adjustable to change the position of the steering wheel to enhance the comfort of the driver. Raking movement and tilting movement change the angular position of the steering wheel. Telescoping movement changes the position of the steering wheel along the axis of the steering column relative to the dash board, the steering wheel moving outward or inward from the dashboard. Adjustable steering columns include locks to prevent movement of the steering wheel after the desired position of the steering wheel has been established.

### SUMMARY OF THE INVENTION AND ADVANTAGES

The invention provides a steering column for a vehicle. The steering column includes a rake bracket having first and second side walls. The steering column also includes a first steering column member disposed between the first and second side walls for raking movement. The first steering column member includes a first aperture and a plurality of projections extending inwardly from the first aperture. The steering column also includes a second steering column member received in the first aperture for telescoping movement relative to the first steering column member. The steering column also includes a lock operable in a locked configuration to concurrently urge the first and second side walls of the rake bracket together to prevent the raking movement and urge the second steering column member and the plurality of projections together to prevent the telescoping movement.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an exploded view of the exemplary embodiment of the invention;

FIG. 2 is a side view of the exemplary embodiment of the invention wherein a lock of the exemplary embodiment is in a locked configuration;

FIG. 3 is a cross-sectional view taken along section lines 3-3 in FIG. 2;

FIG. 4 is a side view of the exemplary embodiment of the invention wherein the lock of the exemplary embodiment is in an unlocked configuration; and

FIG. 5 is a cross-sectional view taken along section lines 5-5 in FIG. 4.

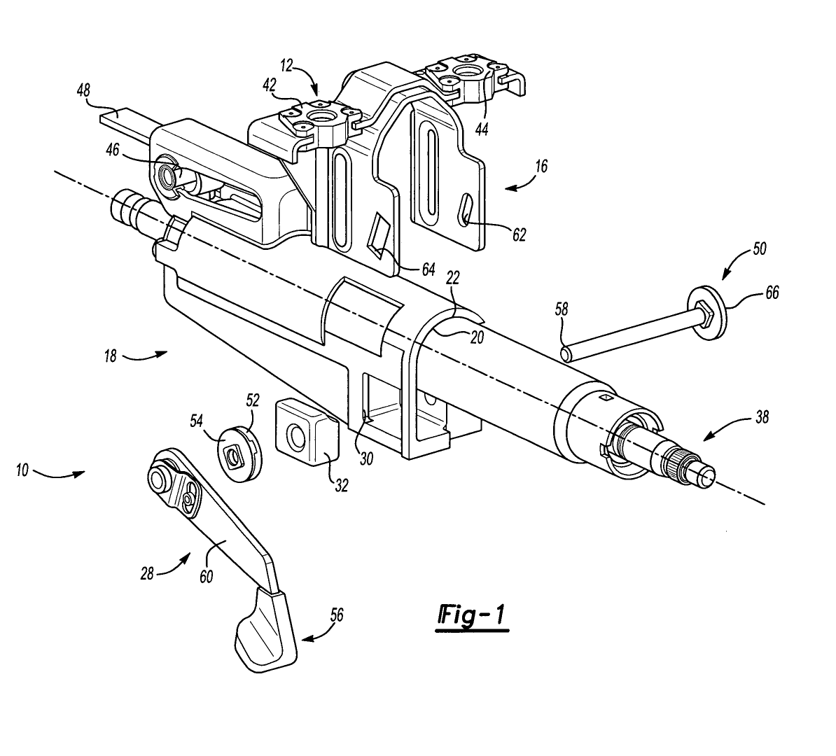

### DETAILED DESCRIPTION OF THE PREFERRED EMBODIMENT

The invention provides a steering column 10 for a vehicle. The steering column 10 includes a rake bracket 12 having first and second side walls 14, 16. The steering column 10 also includes a first steering column member 18 disposed between the first and second side walls 14, 16 for raking movement. The first steering column member 18 includes a first aperture 20 and a plurality of projections 22, 24 extending inwardly from the first aperture 20. The steering column 10 also includes a second steering column member 26 received in the first aperture 20 for telescoping movement relative to the first steering column member 18. The steering column 10 also includes a lock 28 operable in a locked configuration to concurrently urge the first and second side walls 14, 16 of the rake bracket 12 together to prevent the raking movement and urge the second steering column member 26 and the plurality of projections 22, 24 together to prevent the telescoping movement.

The steering column 10 supports a steering shaft 38 in a vehicle. The steering shaft 38 defines a steering wheel supporting end 40 that engages a steering wheel of the vehicle. The first steering column member 18 moves relative to the rake bracket 12 to adjust the steering wheel in raking movement. The rake brake 12 can be releasibly engaged with the vehicle to rigidly support the first and second steering column members 18, 26 during normal vehicle handling and to separate from the vehicle in an impact situation such as a vehicle crash. In the exemplary embodiment of the invention, breakable capsules 42, 44 are operably disposed between the rake bracket 12 and the vehicle. Structure for absorbing energy during in an impact situation can be associated with the rake bracket 12. An anvil 46 and strap 48 are associated with the exemplary rake bracket 12 and cooperate with one another as known in the art.

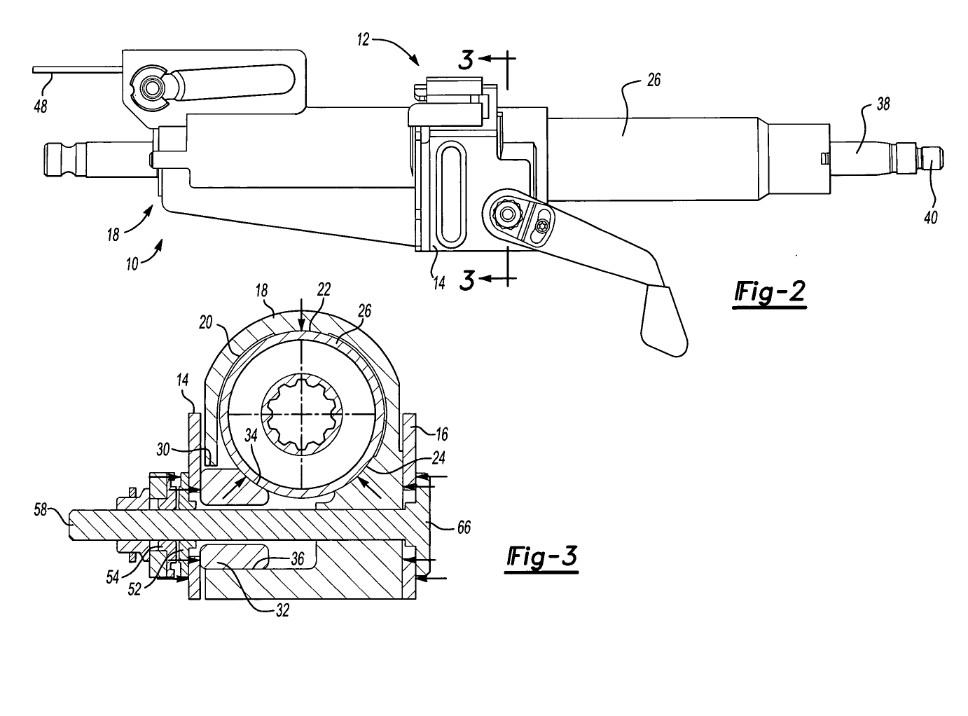

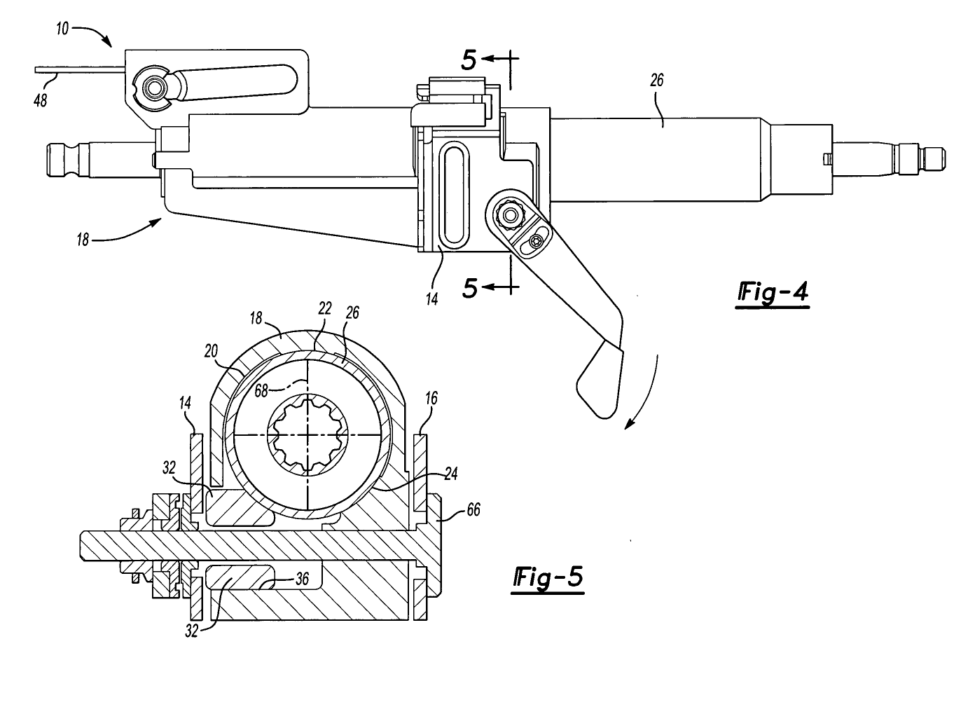

The first steering column member 18 further comprises a second aperture 30 communicating with the first aperture 20. The lock 28 further comprises a wedge member 32 movable between locked and unlocked positions in the second aperture 30. The lock also includes a bolt 50, first and second cams 52 and 54, and a lever assembly 56. The bolt 50 extends through the second aperture 30 and slots 62 and 64 of the rake bracket. The bolt 50 engages the lever assembly 56 at a distal end 58. The lever assembly 56 includes a lever 60 rotatable about the bolt 50 between a locked position, shown in FIG. 2, and an unlocked position, shown in FIG. 4. When the lever 60 rotates from the unlocked position to the locked position, the cams 52, 54 rotate relative to one another and urge each other apart. The cam 54 can be fixed to the lever 60 and the cam 52 can be slidably received in the slot 64. Cooperation between the cam 52 and the slot 64 allows the cam 52 to move in the slot during raking movement and prevents the cam 52 from rotating about the bolt 50. Movement of the cams 52, 54 apart from one another, in cooperation with a head 66 of the bolt 50, compress the first and second side walls 14, 16, against the first steering column member 18, preventing raking movement. The cam 52 and head 66 are urged together by rotation of the lever from the unlocked position to the locked position.

The wedge member 32 encircles the bolt 50 and is urged to the locked position by the movement of the of the cams 52, 54 apart from one another. The wedge member 32 includes an engaging surface 34 contacting the second steering column member 26 when the wedge member 32 is in the locked position. FIG. 3 shows the wedge member 32 in the locked position and FIG. 5 shows the wedge member 32 in the unlocked position. Each figure shows the engaging surface 34 contacting the second steering column member 26; movement of the wedge member 32 can be slight. When the wedge member 32 is in the locked position, the second steering column member 26 is pressed between the engaging surface 34, the projection 22 and the projection 24 and locked with respect to telescoping movement. As result, the second steering column member 26 is engaged at more than two contact points to telescopically lock the steering column 10. This arrangement enhances the rigidity of the steering column 10 during normal vehicle handling and also enhances the strength of the lock 28 in an impact situation. The wedge member 32 includes a second engaging surface 36 contacting the second aperture 30 of the die case first steering column member 18 when the wedge member 32 is in the locked position.

The engaging surface 34 and the plurality of projections 22, 24 are symmetrically spaced about the second steering column member 26 when the wedge member 32 is in the locked position. As shown in FIGS. 3 and 5, the projection 22 is disposed along an axis 68 extending perpendicular to the axis of the steering column 10. The projection 24 and the engaging surface 34 engage the second steering column member 26 at positions greater than 120° from the projection 22 and are disposed in mirror relation to another relative to the axis 68. The projection 22, the projection 24, and the engaging surface 34 could engage the second steering column member 26 at positions equally spaced from one another, such as being 120° from one another. In alternative embodiments of the invention, the first steering column member 18 could include more than two projections and/or the projections could be randomly spaced about the second steering column member 26.

The first steering column member 18 of the exemplary embodiment of the invention is a die cast steering column member. This reduces the relative mass of the steering column 10 relative to column members having a steel first steering column member. The second steering column member 26 of the exemplary embodiment of the invention is a steel steering column member. This reduces the relative cost of the steering column 10 relative to column members having a die cast second steering column member.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A steering column for a vehicle comprising:
a rake bracket having first and second side walls;
a first steering column member disposed between said first and second side walls for raking movement and having a first aperture and a plurality of projections extending inwardly from said first aperture;
a second steering column member received in said first aperture for telescoping movement relative to said first steering column member; and
a lock operable in a locked configuration to concurrently urge said first and second side walls of said rake bracket together to prevent said raking movement and urge said second steering column member and said plurality of projections together to prevent said telescoping movement.

2. The steering column of claim 1 wherein:
said first steering column member further comprises a second aperture communicating with said first aperture; and
said lock further comprises a wedge member movable between locked and unlocked positions in said second aperture and having an engaging surface contacting said second steering column member when said wedge member is in said locked position.

3. The steering column of claim 2 wherein said engaging surface and at least one of said plurality of projections are symmetrically spaced about said second steering column member when said wedge member is in said locked position.

4. The steering column of claim 3 wherein said first steering column member is further defined as being a die cast steering column member.

5. The steering column of claim 4 wherein said second steering column member is further defined as being a steel steering column member.

6. The steering column of claim 5 wherein said wedge member includes a second engaging surface contacting said second aperture of said die case first steering column member when said wedge member is in said locked position.

7. The steering column of claim 2 wherein said first steering column member is further defined as having two projections that extend into said first aperture.

8. The steering column of claim 7 wherein one of said two projections is spaced closer to said engaging surface than the other of said two projections.

9. The steering column of claim 2 wherein said first steering column member is further defined as having an even number of projections that extend into said first aperture.
